(19) United States
(12) Patent Application Publication
(10) Pub. No.: US 2012/0099521 A1
(43) Pub. Date: Apr. 26, 2012

(54) CENTER DISTRICT DUAL MODE NETWORK SYNCHRONIZATION ACQUISITION METHOD AND APPARATUS FOR SATELLITE COMMUNICATION SYSTEM

(75) Inventors: Joon Gyu RYU, Daejeon (KR); Minsu Shin, Daejeon (KR); Deock Gil Oh, Daejeon (KR)

(73) Assignee: ELECTRONICS AND TELECOMMUNICATIONS RESEARCH, Daejeon (KR)

(21) Appl. No.: 13/279,358

(22) Filed: Oct. 24, 2011

(30) Foreign Application Priority Data
Oct. 25, 2010 (KR) 10-2010-0104022

(51) Int. Cl. H04W 56/00

(52) U.S. Cl. 370/326

(57) ABSTRACT

A center district network synchronization acquisition apparatus and method capable of accommodating both a GPS mode based terminal and an NCR mode based terminal. The center district network synchronization acquisition apparatus for a satellite communication system according to an exemplary embodiment includes: a timing generating unit configured to generate an interrupt signal by being synchronized with a PPS (pulse per second) signal received from a reference clock generation module, an NCR counter configured to extract a corresponding NCR (network clock reference) value at a timing indicated by the interrupt signal, and a packet generating unit configured to generate an MPEG2-TS packet including the NCR value extracted according to the interrupt signal. Therefore, this apparatus can accommodate both a GPS mode based terminal and an NCR mode based terminal. As a result, the satellite communication system can operate regardless of the network synchronization mode performed by the terminal.

### CROSS-REFERENCE TO RELATED APPLICATIONS

This application claims priority under 35 U.S.C. §119 to Korean Patent Application No. 10-2010-0104022, filed on Oct. 25, 2010, in the Korean Intellectual Property Office, the disclosure of which is incorporated herein by reference in its entirety.

### TECHNICAL FIELD

The prevent invention relates to a center district dual mode network synchronization acquisition apparatus and method for a satellite communication system. More specifically, the present invention relates to a center district network synchronization acquisition apparatus and method that are capable of accommodating GPS mode and NCR mode based terminals for maintaining stable network synchronization.

### BACKGROUND

A high speed bidirectional satellite communication system according to the related art uses DVB-S or DVB-S2 of a TDM manner as a forward direction link, and TDMA based DVB-RCS manner as a reverse direction link. In such a satellite broadcasting and communication system, it is important to constantly maintain the clock and timing synchronization between the center district and a terminal for stable transmission of data.

In the meantime, a synchronization method for a synchronized communication at a known satellite communication system is classified into a method that uses a separate timing generating module such as a GPS and a method that broadcasts network synchronization information including an NCR value using an adaptive field sentence defined in the MPEG-2 system standard to all terminals.

According to the method that uses a GPS module, both the center district and the terminal uses the GPS module to synchronize the timing with a clock using TOD (time of day) information and PPS (pulse per second) information output from the GPS module. However, even though the method that uses a separate timing generating module such as a GPS is stable and provides a precise timing, use of the additional module may increase the product cost.

According to the network synchronization method based on an NCR value, even though multiple MPEG-2 streams are remultiplexed so that even though the position of the network synchronizing packet is changed, an original position of the network synchronization packet is found by using a difference between a reference value of the network synchronization and an original reference value of the network synchronization to generate a transmitting and receiving slot timing. However, the network synchronization method based on NCR has a problem because the method cannot generate an initial connecting timing and a stable clock due to an error generated at the time of restoring the NCR value at the terminal.

In the meantime, a center district network synchronization acquisition apparatus at a conventional satellite communication system supports only one of the GPS mode and NCR mode based terminals. Therefore, the apparatus provides a service with a problem of the above modes.

### SUMMARY

An exemplary embodiment of the present invention provides a center district network synchronization acquisition apparatus for a satellite communication system, including: a timing generating unit configured to generate an interrupt signal by being synchronized with a PPS (pulse per second) signal received from a reference clock generation module; an NCR counter configured to extract a corresponding NCR (network clock reference) value at a timing indicated by the interrupt signal; and a packet generating unit configured to generate an MPEG2-TS packet including the NCR value extracted according to the interrupt signal.

Another exemplary embodiment of the present invention provides a center district dual mode network synchronization acquisition method, including: generating an interrupt signal by being synchronized with a PPS signal received from a reference clock generation module; extracting a corresponding NCR value at a timing indicated by the interrupt signal; and generating an MPEG2-TS packet including the NCR value extracted according to the interrupt signal.

Other features and aspects will be apparent from the following detailed description, the drawings, and the claims.

### BRIEF DESCRIPTION OF THE DRAWINGS

FIG. 1 is a diagram illustrating a configuration of a bidirectional satellite communication system to which an exemplary embodiment of the present invention is applied.

FIG. 2 is a block diagram specifically illustrating a center district dual mode network synchronization acquisition apparatus according to an exemplary embodiment of the present invention.

FIG. 3 is a flow chart illustrating a center district dual mode network synchronization acquisition method according to another exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

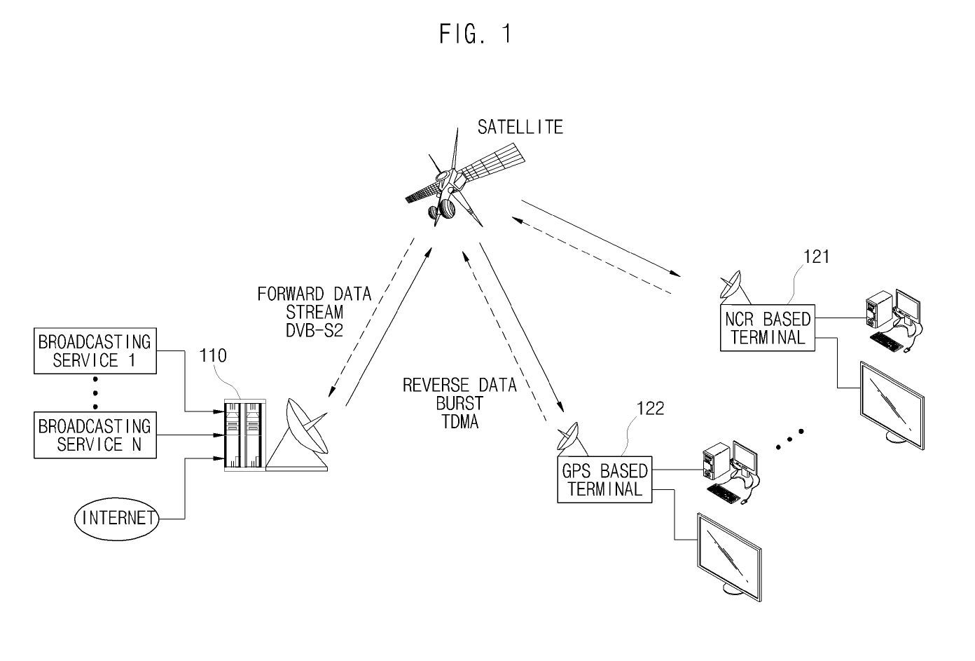

With reference to FIG. 1, a bidirectional satellite communication system to which an exemplary embodiment of the present invention is applied will be described. FIG. 1 is a diagram illustrating a configuration of a bidirectional satellite communication system to which an exemplary embodiment of the present invention is applied.

Referring to FIG. 1, the bidirectional satellite communication system according to the exemplary embodiment of the present invention includes a center district 110, and a GPS based terminal 121 or an NCR (network clock reference) based terminal 122.

The center district 110 includes a center district transmitter that receives various kinds of MPEG2-TS packets for broadcasting and bidirectional communication from an external device from an external device to transmit a forward link in DVB-S or DVB-S2 manner and a center district receiver that receives a signal input to a TDMA based DVB-RCS type reverse link from the GPS and NCR terminals 121 and 122 to demodulate and restore the signal.

The GPS and NCR terminals 121 and 122 receive a signal that is transmitted from the center district 110 to the forward link, and transmits data to the center district 110 using the reverse link.

Here, the center district 110 is connected to Internet to provide a directional satellite communication service, and receives multiple broadcasting streams to provide a broadcasting service and remultiplexes the streams to transmit the streams to the forward link according to a DVB-S or DVB-S2 standard. Further, the center district 110 serves to demodulate the signal transmitted from the multiple terminals 121 and 122 to restore the signal.

The multiple terminals 121 and 122 are provided with a bidirectional satellite communication service transmitted from the center district 110. For such bidirectional satellite communication system, it is important to establish a clock and a timing synchronization between the center district 110 and the terminals 121 and 122 for a synchronized communication.

Currently, in the bidirectional satellite communication system, a specific network synchronization method that is used by the center district is varied depending on a network synchronization method performed by the terminal (for example, which of a GPS or an NCR is used to perform network synchronization).

For example, if the terminal performs network synchronization based on the NCR, the center district 110 creates a pilot signal using a high precision reference frequency generator to broadcast the signal through a dedicate channel, and the NCR terminal 122 receives the pilot signal to establish the clock and timing synchronization.

Both the center district 110 and the GPS terminal 121 may use the GPS module to establish the clock and timing synchronization using TOD information and PPS information output from the GPS module.

As described above, according to the current bidirectional satellite communication system, the center district supports only one specific mode according to the network synchronization method that is performed by the terminal. On the contrary, the center district network synchronization acquisition apparatus according to the exemplary embodiment has a structure which can support both the NCR module and the GPS module. Therefore, the center district network synchronization acquisition apparatus can be operated regardless of a type of network synchronization which is performed by the terminal.

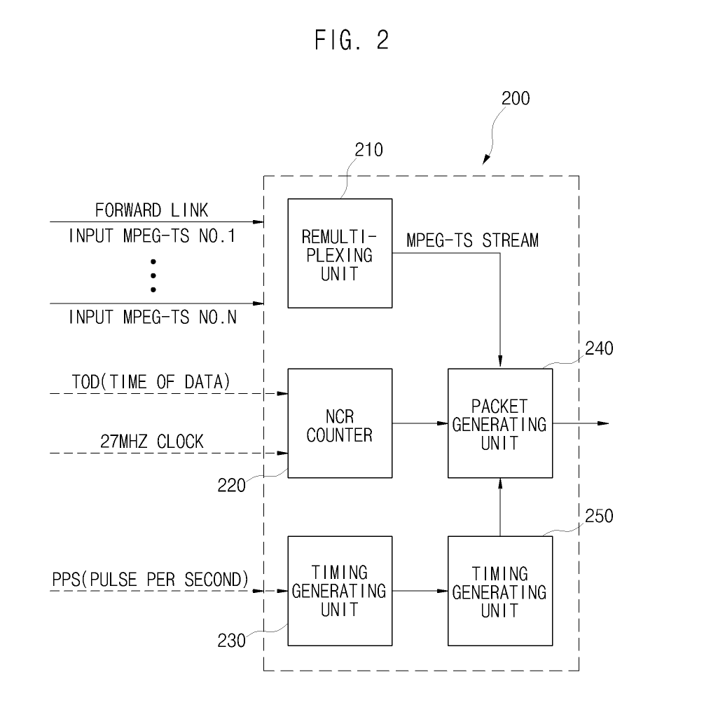

Hereinafter, with reference to FIG. 2, a center district network synchronization acquisition apparatus according to an exemplary embodiment of the invention will be described. FIG. 2 is a block diagram specifically illustrating a center district dual mode network synchronization acquisition apparatus according to an exemplary embodiment of the present invention.

Referring to FIG. 2, the center district dual mode network synchronization acquisition apparatus 200 according to an exemplary embodiment of the invention includes a remultiplexing unit 210, an NCR counter 220, a timing generating unit 230, a packet generating unit 240, and a dynamic resource management unit 250.

The remultiplexing unit 210 receives multiple MPEG2-TS streams including broadcasting and IP data according to the MPEG standard input from the external device from an external device to remultiplex the multiple MPEG2-TS streams to a single MPEG2-TS stream.

When the network synchronization acquisition apparatus 200 is turned on, the NCR counter 220 calculates a current NCR (network clock reference) value using a TOD (time of day) value transmitted from RCG (reference clock generation) module (not shown), and is initialized using the calculated value, and receives 27 MHz clock from the reference clock generation module to be operated.

After the above initialization process, the NCR counter 220 calculates an NCR value (for example, if an NCR counter counts 10 NCR values for one second, the NCR counter calculates 100 NCR values for 10 seconds).

The NCR counter 220 extracts a corresponding NCR value at a timing indicated by an interrupt signal and transmits the extracted NCR value to the packet generating unit 240. Here, the interrupt signal refers to a signal that latches a corresponding NCR value according to a start signal of a super frame synchronized with a PPS (pulse per second) signal received from the reference clock generation module.

The NCR counter 220 is initialized if the TOD value received from the reference clock generation module is 24:00.

The timing generating unit 230 generates a super frame start signal SST by being synchronized with a PPS signal received from the reference clock generation module, and generates a TBTP (terminal burst time plan) interrupt signal (periodic signal for inserting the NCR value) to transmit the signals to the dynamic resource management unit (DRM) 250.

The packet generating unit 240 generates an MPEG2-TS packet including an NCR value latched by the interrupt signal and periodically inserts the MPEG2-TS packet to a single MPEG2-TS stream transmitted from the remultiplexing unit 210.

When a subscriber logs in, the dynamic resource management unit 250 confirms whether there is an available resource, and allocates the requested resource. When there is a request for an additional resource, the dynamic resource management unit 250 maintains an optimized resource allocation status using an efficient allocation technology and generates and transmits service control information required for network connection at the center district and the terminals.

Here, the service control information includes super frame composition table SCT, frame composition table FCT, time slot composition table TCT, and terminal burst time plan table information.

Specifically, the dynamic resource management unit 250 receives an interrupt signal from the timing generating unit 230 and generates a control signal to allow the packet generating unit 240 to generate an MPGE2-TS packet including a latched NCR value.

The MPEG2-TS packet that includes the NCR value is coded by a modulator (not shown), and the coded packet is modulated to a signal to be actually transmitted to be transmitted to the terminal using a communication scheme such as QPSK, 8PSK, 16APSK, and 32APSK.

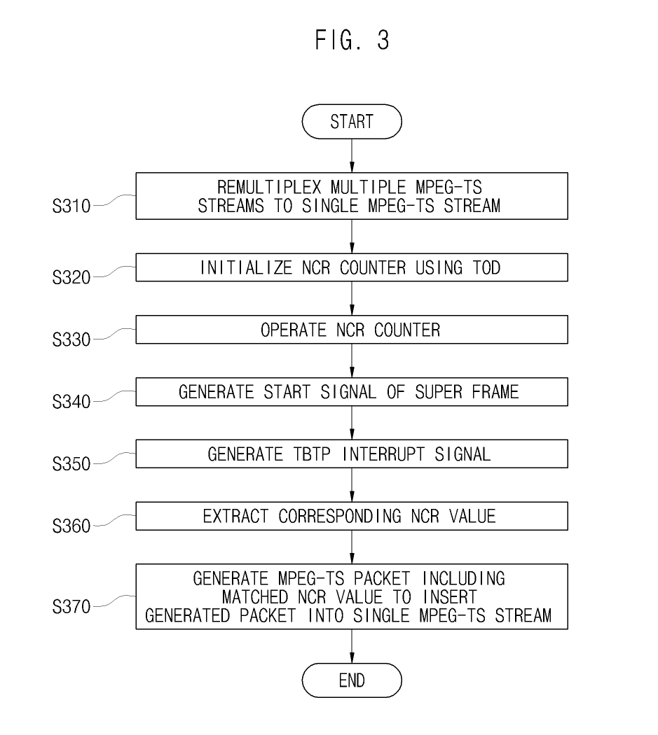

With reference to FIG. 3, a center district network synchronization acquisition method according to another exemplary embodiment of the present invention will be described. FIG. 3 is a flow chart illustrating a center district network synchronization acquisition method according to another exemplary embodiment of the present invention.

The center district network synchronization acquisition apparatus according to an exemplary embodiment of the present invention remultiplexes multiple MPEG2-TS streams for broadcasting and bidirectional communication input from an external device from an external device to a single MPEG2-TS stream (S310).

Next, the center district network synchronization acquisition device calculates a current NCR value using a TOD value received from a reference clock generation module, and initializes the NCR counter using the calculated value (S320).

Next, the center district network synchronization acquisition device operates the NCR counter using 27 MHz clock received from the reference clock generation module (S330). As described above, after the above initialization process, the NCR counter calculates an NCR value (for example, if an NCR counter counts 10 NCR values for one second, the NCR counter calculates 100 NCR values for 10 seconds).

Next, the center district network synchronization acquisition device receives a PPS (pulse per second) signal from the reference clock generation module to generate a start signal of a super frame synchronized with the PPS signal (S340).

Next, the center district network synchronization acquisition device generates a TBTP interrupt signal according to the start signal of the super frame (S350). Here, the interrupt signal refers to a signal that latches a corresponding NCR value according to a start signal of a super frame synchronized with a PPS (pulse per second) signal received from the reference clock generation module.

Next, the center district network synchronization acquisition device extracts a corresponding NCR value at a timing indicated by an interrupt signal (S360).

Next, the center district network synchronization acquisition device generates an MPEG2-TS packet including an NCR value latched by the interrupt signal and periodically inserts the MPEG2-TS packet to a single MPEG2-TS stream (S370).

Hereinafter, GPS and NCR based network synchronization terminals that receive a signal transmitted from the center district to the forward link and transmit data to the center district using a reverse link will be described.

The GPS based network synchronization terminal calculates a current NCR value using a TOD signal received from the GPS and then is initialized to a calculated NCR value.

Further, the terminal uses an internal 27 MHz clock as a PPS signal to be recovered to a closed loop type. Thereafter, the terminal uses the recovered 27 MHz clock to drive the NCR counter and transmits the burst to a timeslot allocated from the center district.

In the meantime, the NCR based network synchronization terminal recovers the 27 MHz clock using an NCR value received from the center district, resets a local counter value using an initial NCR value, and operates the local counter with the 27 MHz clock synchronized with the center district by the recovered 27 MHz clock.

Here, the local counter sets a maximum value that can be counted for 24 hours. If the counter counts the maximum value, the counter is reset and then counts again.

After network clock recovery is completed, the NCR based network synchronization terminal corrects the local counter using an error transmitted from the center district to maintain the network synchronization.

The local counter is reset after counting only an NCR value corresponding to one day in order to prevent the discontinuity between the center district NCR value and the terminal NCR value from occurring when the terminal does not use a GPS module.

According to the exemplary embodiment, this invention can be embodied as computer applicable program and embodied in a general digital computer that operates programs using a computer readable storage medium. Examples of the computer readable storage medium include a magnetic storage medium (for example, ROM, a floppy disk, a hard disk, or the like), an optical reading medium (for example, CD-ROM, DVD, or the like), and a carrier wave (for example, transmission through Internet).

According to the exemplary embodiments of the present invention, a center district dual mode network synchronization acquisition apparatus for a bidirectional satellite communication system can accommodate both a GPS mode based terminal and an NCR mode based terminal. As a result, the satellite communication system can operate regardless of the network synchronization mode performed by the terminal.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A center district dual mode network synchronization acquisition apparatus for a satellite communication system that includes a transmitter transmitting broadcasting and communication data to a forward link and a receiver processing a signal input from a terminal to a reverse link, the apparatus comprising:
a timing generating unit configured to generate an interrupt signal by being synchronized with a PPS (pulse per second) signal received from a reference clock generation module;
an NCR counter configured to extract a corresponding NCR value at a timing indicated by the interrupt signal; and
a packet generating unit configured to generate an MPEG2-TS packet including the NCR value extracted according to the interrupt signal.

2. The apparatus of claim 1, further comprising:
a remultiplexing unit configured to receive multiple MPEG2-TS streams including broadcasting and IP data according to the MPEG standard input from an external device from an external device to remultiplex the streams to a single MPEG2-TS stream.

3. The apparatus of claim 1, wherein the NCR counter calculates a current NCR value using a TOD (time of day) value received from the reference clock generation module to be initialized and is operated by a 27 MHz clock received from the reference clock generation module.

4. The apparatus of claim 1, wherein the timing generating unit generates a super frame start signal SST by being synchronized with the PPS signal received from the reference clock generation module and generates the interrupt signal according to the start signal.

5. The apparatus of claim 1, further comprising:
a dynamic resource management unit configured to output a control signal that allows the packet generating unit to generate the MPEG2-TS packet including the extracted NCR value according to the interrupt signal received from the timing generating unit.

6. The apparatus of claim 1, wherein the NCR counter is initialized if the TOD value received from the reference clock generation module is 24:00.

7. A center district dual mode network synchronization acquisition method for a satellite communication system, the method comprising:
generating an interrupt signal by being synchronized with a PPS signal received from a reference clock generation module;
extracting a corresponding NCR value at a timing indicated by the interrupt signal; and
generating an MPEG2-TS packet including the NCR value extracted according to the interrupt signal.

8. The method of claim 7, wherein the generating of the interrupt signal includes:
generating a start signal of a super frame synchronized with the PPS signal received from the reference clock generation module; and
generating a TBTP interrupt signal that latches a corresponding NCR value according to the synchronized start signal of the super frame.

9. The method of claim 7, wherein the extracting of the corresponding NCR value includes:
calculating a current NCR value using a TOD (time of day) value received from the reference clock generation module to initialize an NCR counter; and
operating the NCR counter with a 27 MHz clock received from the reference clock generation module.

10. The method of claim 7, further comprising:
remultiplexing multiple MPEG2-TS streams for broadcasting and bidirectional communication input from an external device from an external device to a single MPEG2-TS stream.

11. The method of claim 10, wherein the generating of the MPEG2-TS packet includes:
periodically inserting the generated MPEG2-TS packet into the remultiplexed single MPEG2-TS stream.
